(19) United States
(12) Patent Application Publication
(10) Pub. No.: US 2004/0189199 A1
(43) Pub. Date: Sep. 30, 2004

(54) Plasma display panel

(75) Inventors: Toshihiro Komaki, Yamanashi-ken (JP); Naruhiko Atsughi, Yamanashi-ken (JP); Satoshi Jinno, Yamanashi-ken (JP); Takahiro Togashi, Yamanashi-ken (JP); Masaki Yoshinari, Yamanashi-ken (JP); Kazuya Akiyama, Yamanashi-ken (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Pioneer Corporation

(21) Appl. No.: 10/819,923

(22) Filed: Apr. 8, 2004

(30) Foreign Application Priority Data
Apr. 9, 2003 (JP) 2003-104878
Feb. 9, 2003 (JP) 2003-104879
May 21, 2003 (JP) 2003-143294

(51) Int. Cl. H01J 17/49

(52) U.S. Cl. 313/582; 313/586; 313/587

(57) ABSTRACT

A front glass substrate is opposite a back substrate with a discharge space in between. On the rear-facing face of the front glass substrate are provided a plurality of row electrode pairs each extending in the row direction and regularly arranged in the column direction to individually form display lines; and a plurality of column electrodes each extending in a direction at right angles to the row electrode pairs and separated from the row electrode pair by a first dielectric layer. A partition wall partitions the discharge space into discharge cells each opposite the opposed transparent electrodes of the row electrode pair. In the plasma display panel structured in this manner, the back substrate is constituted of a metal plate having the surface covered with an insulation layer.

### BACKGROUND OF THE INVENTION

1. Field of the Invention

This invention relates to a panel structure for surface-discharge-type AC plasma display panels.

The present application claims priority from Japanese Applications No. 2003-104878, 2003-104879, and 2003-143294, the disclosures of which are incorporated herein by reference.

2. Description of the Related Art

Surface-discharge-type AC plasma display panels (hereinafter referred to as “PDP”) have recently gained the spotlight as types of large-sized slim color display apparatuses and are becoming increasingly common in homes and the like.

For the achievement of cost reduction and a high definition display-image, some types of such surface-discharge-type AC PDPs have a double layer structure in which row electrode pairs and column electrodes extending in a direction at right angles to the row electrode pairs are formed, with a dielectric layer in between, on one glass substrate opposing the other substrate on which a phosphor layer is formed.

FIG. 1 is a front view of the structure of a conventional PDP having both the row electrode pairs and the column electrodes formed on one substrate of the opposed substrates, which is described in Japanese Patent Laid-open Application No. 10-321145.

Regarding the structure illustrated in FIG. 1, on the inner face of one substrate in a pair of substrates of the PDP facing each other, a plurality of row electrode pairs (X, Y) each constituted of paired row electrodes X and Y extend in the row direction and are arranged in parallel in the column direction, and covered by a dielectric layer (not shown) which is the first layer. Body portions Da of a plurality of column electrodes D each extend in the column direction and are arranged in parallel at regular intervals in the row direction on the rear-facing face of the dielectric layer of the first layer, and covered by another dielectric layer (not shown) which is the second layer.

Each of discharge portions Db of each column electrode D is positioned inside the first dielectric layer so as to be flush with and opposite to the row electrode X or Y in the row electrode pair (X, Y) which initiates an addressing discharge in association with the discharge portion Db.

At each area surrounded by the paired row electrodes X and Y and the body portions Da of the two adjacent column electrodes D, a discharge cell C is formed in the discharge space defined between the two substrates.

Each of the row electrode pairs (X, Y) forms a display line L.

The surface-discharge-type AC PDP display images as follows:

In a reset period, a reset discharge is produced simultaneously in all the discharge cells C between one row electrode in the row electrode pair (X, Y) (in this case, the row electrode X) and the discharge portion Db of the column electrode. D. Then in the subsequent addressing period, an addressing discharge is produced between the row electrode X and the discharge portion Db of the column electrode Din each of the selected discharge cells C, whereby the lighted cells (the discharge cells C having wall charges generated on the dielectric layer) and the non-lighted cells (the discharge cells C having no wall charges generated on the dielectric layer) are distributed over the panel surface in accordance with the image to be displayed.

After the completion of the addressing period, a discharge-sustaining pulse is alternately applied, simultaneously in all the display lines L, to the row electrodes X and Y in each row electrode pair. Thereupon, due to the wall charges accumulated on the dielectric layer, a sustain discharge is produced between the row electrodes X and Y in each lighted cell with every application of the discharge-sustaining pulse.

As a result of the sustain discharge, ultraviolet light is generated from the discharge gas in each light cell, and excites each of the red (R), green (G) and blue (B) colored phosphor layers formed on the other substrate in the individual discharge cells C, to emit visible light for the generation of the images.

The conventional surface-discharge-type AC PDP structured as described hitherto has the following problems.

One of the problems is the weight, because the conventional PDP uses glass substrates for the two substrates opposite each other with the discharge space in between. Another problem is the low degree of its heat-dissipation property when the heat generated by the discharge is released from the discharge space.

Yet another problem of the conventional PDP is the high manufacturing costs because of the need of high precision in the positional relationship between the electrodes in between the front glass substrate and the back glass substrate. A further factor that increases the manufacturing costs is the great number of components formed on each substrate.

Further, a three-electrode reflection type of PDP needs to produce a discharge in each discharge cell capable of achieving a high light-emission efficiency in order to generate a high-luminance picture. However, in this case, the problem is the difficulty in increasing the light-emission efficiency in the discharge cells without raising the voltage required for starting the addressing discharge produced between the column electrode and the row electrode.

### SUMMARY OF THE INVENTION

The present invention is mainly designed to solve the problems associated with the conventional surface-discharge-type AC plasma display panels as described hitherto.

It is a first object of the present invention to provide a plasma display panel reduced in weight and improved in its heat-dissipation property.

It is a second object of the present invention to provide a plasma display panel capable of being manufactured by a simplified process.

It is a third object of the present invention to achieve an improvement in light-emission efficiency without raising the starting voltage required for an addressing discharge in a three-electrode reflection-type plasma display panel.

To attain the first object, in a first aspect of the present invention, the plasma display panel comprises: a front substrate; a back substrate that is constituted of a metal plate having a surface covered with an insulation layer and located opposite the front substrate with a discharge space in between; a plurality of row electrode pairs that each extend in a row direction and are regularly arranged in a column direction on a rear-facing face of the front substrate to individually form display lines; a plurality of column electrodes each of which extends in a direction at right angles to the row electrode pair on the rear-facing face of the front substrate, and is separated from the row electrode pair by a dielectric layer; and a partition wall for partitioning the discharge space into unit light-emission areas each positioned opposite to discharge portions facing each other in the row electrode pair.

According to the first aspect, the back substrate is positioned opposite the front substrate to define a discharge space in which a discharge for the generation of an image is produced by use of the row electrode pair and the column electrode which are formed on the front substrate. This back substrate of the plasma display panel according to the present invention is created by covering the surface of a metal plate with an insulation layer. Thus, as compared with a conventional plasma display panel having a back substrate constituted of a glass substrate, the present invention achieves a reduction in weight of the plasma display panel. Further, the back substrate formed of the metal plate has adequate thermal conductivity, so that the heat produced by a discharge in the discharge space is easily released through the back substrate into the atmosphere, resulting in an improvement in the heat-dissipation property of the entire plasma display panel.

To attain the second object, in a second aspect of the present invention, the plasma display panel comprises: a pair of first and second substrates that are opposite each other with a discharge space in between; a plurality of row electrode pairs that each extend in a row direction and are regularly arranged in a column direction on the first substrate; a plurality of column electrodes that each extend in the column direction and are regularly arranged in the row direction on the first substrate, and each has a portion providing for initiating a discharge in association with one row electrode in the row electrode pair; dielectric layers that are provided on the first substrate and cover the row electrode pairs and the column electrodes; unit light-emission areas that are formed at each area, corresponding to opposed portions in each row electrode pair, in the discharge space; and a metal-made partition wall that has the metal surface covered with an insulation layer and is provided between the pair of first and second substrates for defining each of the unit light-emission areas.

In the plasma display panel according to the second aspect, in an addressing period subsequent to a simultaneous-reset period in the discharge period, a scan pulse is applied to one row electrode constituting the row electrode pair, and a display data pulse generated according to display data in an image signal is applied selectively to the column electrodes formed on the same substrate as the row electrode pairs are formed on. Thereupon, an addressing discharge is produced between the row electrode receiving the scan pulse and a portion of the column electrode close to this row electrode. As a result, the unit light-emission areas defined by the metallic partition wall are grouped into unit light-emission areas having wall charges generated and unit light-emission areas having no wall charge generated, which are distributed over the panel surface.

In the sustaining emission period subsequent to the addressing period, a discharge sustaining pulse is applied alternately to both row electrodes of the row electrode pair. Thereupon, in the unit light-emission areas having the wall charges generated, a sustain discharge is produced across the discharge gap between the row electrodes, to allow the phosphor layer facing the discharge space in each unit light-emission area to emit visible light for the generation of the image in the form of matrix display.

The second aspect structures the plasma display panel such that the row electrode pairs and the column electrode are provided on one single substrate. This structure makes it possible to simplify the manufacturing process for the plasma display panels and therefore achieve a significant reduction in manufacturing costs.

Further, the partition wall for partitioning the discharge space defined between the pair of the substrates into the unit light-emission areas takes the form of a metallic partition wall of a predetermined shape. This structure allows a further simplification in the manufacturing process and facilitates the alignment between the metallic partition wall and the pair of substrates. This facilitated alignment makes it possible to significantly simplify the manufacturing process.

To attain the third object, in a third aspect of the present invention, the plasma display panel comprises: a pair of first and second substrates that are opposite each other with a discharge space in between; a plurality of row electrode pairs that each extend in a row direction and are arranged regularly in a column direction on the first substrate; a dielectric layer that is provided on the first substrate and covers the row electrode pairs; phosphor layers that are provided on the second substrate; unit light-emission areas defined inside the discharge space between the pair of first and second substrates in each area corresponding to opposed portions of the row electrodes constituting each row electrode pair; a partition wall that is provided between the pair of first and second substrates for defining each of the unit light-emission areas; a plurality of column electrodes that are arranged regularly in the row direction each extend in the column direction in a position at a shorter distance from the one row electrode than a distance between the pair of first and second substrates, to provide for initiating a discharge in association with the one row electrode in each row electrode pair; and a discharge gas of a noble-gas mixture including 10 percents or more of xenon sealed in the discharge space.

In the plasma display panel according to the third aspect, in an addressing period subsequent to the simultaneous-reset period in the discharge period, a scan pulse is applied to one row electrode in the row electrode pair, and a display data pulse generated according to display data in a image signal is applied selectively to the column electrodes. Thereupon, an addressing discharge is produced between the row electrode receiving the scan pulse and the column electrode located close to this row electrode. As a result, the unit light-emission areas defined by the partition wall are grouped into unit light-emission areas having wall charges generated on the dielectric layer and unit light-emission areas having no wall charge generated on the dielectric layer, which are distributed over the panel surface.

In the sustaining emission period subsequent to the addressing period, a discharge sustaining pulse is applied alternately to both row electrodes of the row electrode pair. Thereupon, in the unit light-emission areas having the wall charges generated, a sustain discharge is produced across the discharge gap formed between the row electrodes.

The sustain discharge effects the radiation of vacuum ultraviolet light from the xenon included in the discharge gas sealed in the discharge space. The vacuum ultraviolet light excites the red-, green- and blue-colored phosphor layers to allow the phosphor layers to emit visible light for the generation of the image in the form of matrix display.

At this point, because the discharge gas sealed in the discharge space includes 10 percent or more of xenon, the amount of radiation of vacuum ultraviolet light from the xenon is increased as compared with the case in the conventional three-electrode reflection-type plasma display panel, and therefore the amount of light emitted from the phosphor layers excited by the vacuum ultraviolet light is increased, resulting in an improvement in light-emission efficiency of the plasma display panel.

The column electrode of the foregoing plasma display panel is situated in a position at a shorter distance from one row electrode of the paired row electrodes, that initiates the addressing discharge in association therewith, than the distance between the pair of substrates. This results in the discharge distance being shorter than in the case of the conventional plasma display panel. For this reason, even in the use of a noble-gas mixture including 10 percent or more of xenon as the discharge gas, it is possible to avoid raising the starting voltage required for starting an addressing discharge.

These and other objects and features of the present invention will become more apparent from the following detailed description with reference to the accompanying drawings.

### BRIEF DESCRIPTION OF THE DRAWINGS

FIG. 1 is a schematic front view of the structure of a conventional PDP.

FIG. 2 is a schematic front view illustrating a first embodiment according to the present invention.

FIG. 3 is a sectional view taken along the V1-V1 line in FIG. 2.

FIG. 4 is a sectional view taken along the V2-V2 line in FIG. 2.

FIG. 5 is a sectional view taken along the W1-W1 line in FIG. 2.

FIG. 6 is a sectional view taken along the W2-W2 line in FIG. 2.

FIG. 7 is a schematic front view illustrating a second embodiment according to the present invention.

FIG. 8 is a sectional view taken along the V3-V3 line in FIG. 7.

FIG. 9 is a sectional view taken along the V4-V4 line in FIG. 7.

FIG. 10 is a sectional view taken along the W3-W3 line in FIG. 7.

FIG. 11 is a sectional view taken along the W4-W4 line in FIG. 7.

FIG. 12 is a schematic front view illustrating a third embodiment according to the present invention.

FIG. 13 is a sectional view taken along the V11-V11 line in FIG. 12.

FIG. 14 is a sectional view taken along the V12-V12 line in FIG. 12.

FIG. 15 is a sectional view taken along the W11-W11 line in FIG. 12.

FIG. 16 is a plan view of the structure of the partition wall in the third embodiment.

FIG. 17 is a sectional view taken along the W12-W12 line in FIG. 16.

FIG. 18 is a plan view of the structure of the back glass substrate in the third embodiment.

FIG. 19 is a sectional side view illustrating the back glass substrate with the display-panel partition wall of FIG. 16 mounted thereon.

FIG. 20 is a schematic front view illustrating a fourth embodiment according to the present invention.

FIG. 21 is a sectional view taken along the V21-V21 line in FIG. 20.

FIG. 22 is a sectional view taken along the V22-V22 line in FIG. 20.

FIG. 23 is a sectional view taken along the W21-W21 line in FIG. 20.

FIG. 24 is a schematic front view illustrating a fifth embodiment according to the present invention.

FIG. 25 is a sectional view taken along the V23-V23 line in FIG. 24.

FIG. 26 is a sectional view taken along the V24-V24 line in FIG. 24.

FIG. 27 is a sectional view taken along the W22-W22 line in FIG. 24.

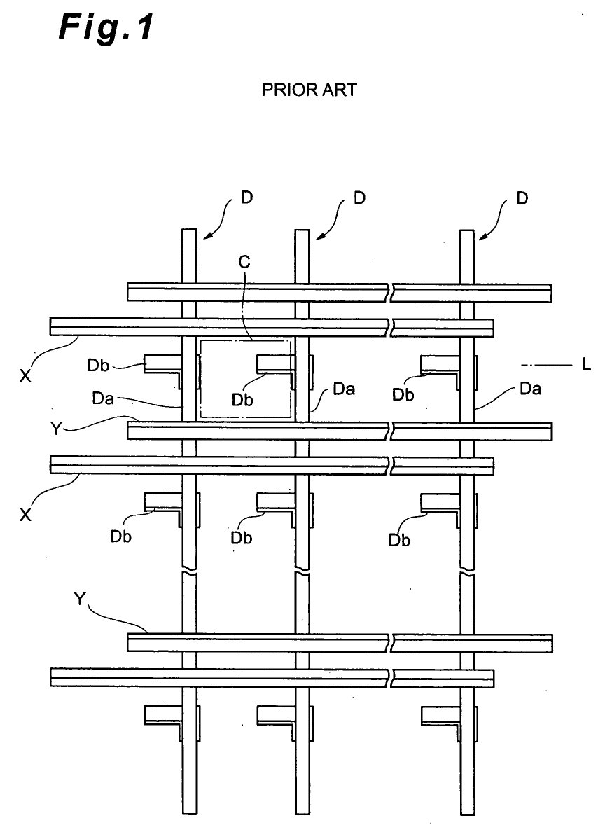

### DETAILED DESCRIPTION OF THE PREFERRED EMBODIMENTS

Preferred embodiments according to the present invention will be described below in detail with reference to the accompanying drawings.

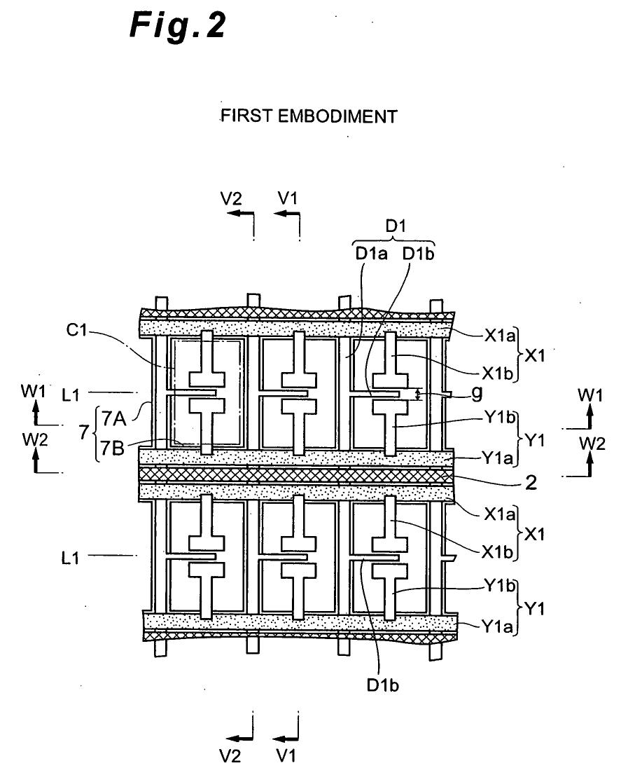

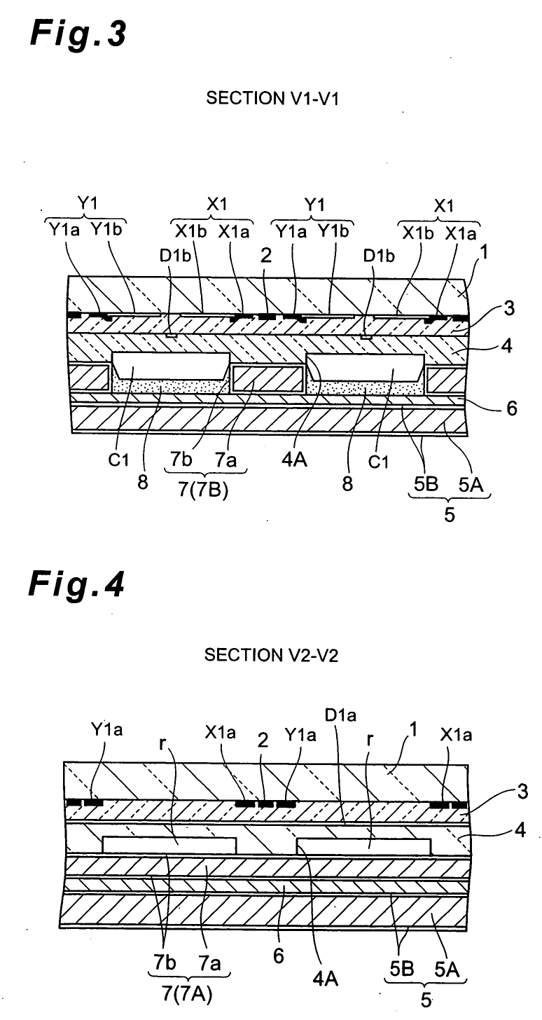

FIG. 2 to FIG. 6 are schematic diagrams illustrating a first embodiment of a plasma display panel (hereinafter referred to as “PDP”) according to the present invention: FIG. 2 is a schematic front view of the PDP and FIGS. 3, 4, 5 and 6 are sectional views respectively taken along the V1-V1 line, the V2-V2 line, the W1-W1 line and the W2-W2 line as shown in FIG. 2.

The PDP illustrated in FIG. 2 to FIG. 6 has a plurality of row electrode pairs (X1, Y1) arranged parallel to each other and extending in the row direction of a front glass substrate 1 (the right-left direction in FIG. 2) on the rear-facing face (i.e. the inner face) of the front glass substrate 1 which serves as the display screen.

The row electrode X1 is composed of a bus electrode X1a formed of a black- or dark-colored metal film extending in the row direction of the front glass substrate 1, and transparent electrodes X1b formed of a T-shaped transparent conductive film made of ITO or the like. The transparent electrodes X1b are lined up along the bus electrode X1a at regular intervals and connected at the respective proximal ends (corresponding to the foot of the T shape) to the bus electrodes X1a.

Likewise, the row electrode Y1 is composed of a bus electrode Y1a formed of a black- or dark-colored metal film extending in the row direction of the front glass substrate 1, and transparent electrodes Y1b formed of a T-shaped transparent conductive film made of ITO or the like. The transparent electrodes Y1b are lined up along the bus electrode Y1a at regular intervals and connected at the respective proximal ends to the bus electrodes Y1a.

The row electrodes X1 and Y1 are arranged in alternate positions in the column direction of the front glass substrate 1 (i.e. the vertical direction in FIG. 2). The transparent electrodes X1b and Y1b lined up along the corresponding bus electrodes X1a and Y1a at regular intervals extend toward the other of the row electrodes of the paired transparent electrodes, so that the two distal widened-ends (corresponding to the head of the T shape) of the transparent electrodes X1b and Y1b in the row electrode pair face each other with a discharge gap g having a required width in between.

Each of the row electrode pairs (X1, Y1) forms a display line L1 of the display panel.

Black- or dark-colored light absorption layers (light-shield layers) 2 are further formed on the rear-facing face of the front glass substrate 1. Each of the light absorption layers 2 extends in bar form in the row direction along and between the back-to-back bus electrodes X1a and Y1a of the row electrode pairs (X1, Y1) adjacent each other in the column direction.

The row electrode pairs (X1, Y1) and the light absorption layers 2 are covered with a first dielectric layer 3 formed on the rear-facing face of the front glass substrate 1.

A plurality of column electrodes D1 is formed on the rear-facing face of the first dielectric layer 3. The column electrodes D1 each extend in the column direction and are arranged in the row direction at regular intervals.

Each of the column electrodes D1 is composed of a strip-shaped column-electrode body D1a and strip-shaped column-electrode discharge portions D1b. The column-electrode body D1a extends in a direction at right angles to the bus electrodes X1a, Y1a (i.e. in the column direction), and is opposite a position midway between the adjacent transparent electrodes X1b and the adjacent transparent electrodes Y1b which are lined up along the corresponding bus electrodes X1a and Y1a of the row electrodes X1 and Y1 at regular intervals in the row direction. The column-electrode discharge portion D1b is formed integrally with the column-electrode body D1a and extends from the side edge of the column-electrode body D1a in the row direction in each display line L1. The leading end of the column-electrode discharge portion D1b is situated opposite the mid-position in a discharge gap g formed between the paired transparent electrodes X1b and Y1b facing each other.

The column-electrode bodies D1a and the column-electrode discharge portions D1b of the column electrodes D1 are covered with a second dielectric layer 4 formed on the rear-facing face of the first dielectric layer 3.

Bar-shaped additional dielectric layers 4A protrude from the rear-facing face of the second dielectric layer 4 toward the rear of the PDP. Each of the additional dielectric layers 4A extents along the bus electrodes X1a, Y1a in the row direction in a position opposite to the back-to-back bus electrodes X1a and Y1a of the row electrode pairs (X1, Y1) adjacent to each other and to the light absorption layer 2 provided between the back-to-back bus electrodes X1a and Y1a concerned.

A MgO-made protective layer (not shown) is formed on the rear-facing faces of the second dielectric layer 4 and the additional dielectric layers 4A.

The inner face of the foregoing front glass substrate 1 faces a back substrate 5 in parallel therewith, with the discharge space in between.

The back substrate 5 is constituted by covering the entire surface of a metal plate 5A, which is a base material, with an insulation layer 5B.

A third dielectric layer 6 is formed on the screen-facing face (i.e. the inner face) of the back substrate 5 facing toward the front glass substrate 1.

A partition wall 7 shaped as will be described below is formed on the third dielectric layer 6.

Specifically, the partition wall 7 is constituted by covering the entire surface of a metal-made base material 7a with an insulation layer 7b, and formed almost in a grid shape by strip-shaped vertical walls 7A and strip-shaped lateral walls 7B. Each of the vertical walls 7A extends in the column direction in a position opposite the column-electrode body D1a formed on the front glass substrate 1. Each of the lateral walls 7B extends in the row direction in a position opposite to the back-to-back bus electrodes X1a and Y1a of the adjacent row electrode pairs (X1, Y1) and to the light absorption layer 2 between the bus electrodes X1a and Y1a concerned.

The partition wall 7 is secured to the back substrate 5 through the third dielectric layer 6.

The partition wall 7 partitions the discharge space defined between the front glass substrate 1 and the back substrate 5 into areas each opposite to the paired transparent electrodes X1b and Y1b in the row electrode pair (X1, Y1) and the column-electrode discharge portion D1b, to individually form quadrangular discharge cells C1.

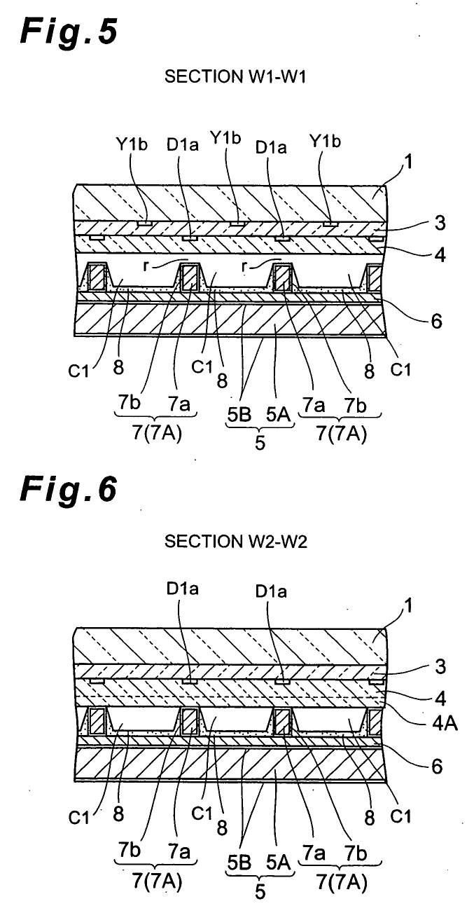

The screen-facing face of the vertical wall 7A of the partition wall 7 is out of contact with the protective layer covering the additional dielectric layer 4A (see FIGS. 4 and 5), to form a clearance r between itself and the protective layer. The screen-facing face of the lateral wall 7B is in contact with a portion of the protective layer covering the additional dielectric layer 4A, to block the adjacent discharge cells C1 from each other in the column direction (see FIGS. 3 and 6).

Phosphor layers 8 are formed individually in the discharge cells C1. Each of the phosphor layers 8 is formed on the five faces facing each discharge cell C1, namely, the face of the third dielectric layer 6 and the side faces of the vertical walls 7A and lateral walls 7B of the partition wall 7. The colors used for the phosphor layers 8 are three primary colors red (R), green (G) and blue (B), that is the red (R) discharge cell C1, the green (G) discharge cell C1 and the blue (B) discharge cell C1 are arranged in order in the row direction.

The discharge space between the front glass substrate 1 and the back substrate 5 is filled with a discharge gas including xenon Xe.

The aforementioned PDP generates images as follows.

In a simultaneous reset period, a reset discharge is produced between the row electrodes X1 and Y1 or alternatively between one of the row electrodes and the column-electrode discharge portion D1b of the column electrode D1. Then, in the subsequent addressing period, a scan pulse is applied to the row electrode Y1, and a display data pulse generated according to display data in an image signal is applied to the column electrode D1. Thereupon, in the selected discharge cells C1, an addressing discharge is produced between the column-electrode discharge portion D1b of the column electrode D1 and the transparent electrode Y1a of the row electrode Y1 receiving the scan pulse. Thereby, wall charges are generated on the first dielectric layer 3 and the second dielectric layer 4 facing the inside of the discharge cells C1 subjected to the addressing discharge.

As a result, the lighted cells (the discharge cells C1 having wall charges formed on the first dielectric layer 3 and the second dielectric layer 4) and the non-lighted cells (the discharge cells C1 having no wall charges generated) are distributed over the panel surface in accordance with the image to be displayed.

After that, in the subsequent sustaining emission period, a discharge-sustaining pulse is applied to the row electrodes X1 and Y1 to produce a sustain discharge between the transparent electrodes X1b and Y1b of the respective row electrodes X1 and Y1 facing each other with the discharge gap g in between in each of the lighted cells having wall charges on the first and second dielectric layers 3 and 4.

This sustain discharge effects the radiation of vacuum ultraviolet light from the xenon included in the discharge gas sealed in the discharge space. The vacuum ultraviolet light excites the red (R)-, green (G)- and blue (B)-colored phosphor layers 8 to allow the phosphor layers to emit visible color light for the generation of the image in the form of matrix display.

At this point, because the column-electrode discharge portion D1b of the column electrode D1 is placed in a midway position in the discharge gap g, part of the electric force lines generated between the transparent electrodes X1b and Y1b (the electric force lines in the vicinity of the surface of the dielectric layer above the discharge gap g) is attracted toward the column-electrode discharge portion D1b, so that the concentration of the electric field onto the center of the discharge is avoided to improve the light-emission efficiency.

With the aforementioned PDP structure, as compared with the conventional PDP having a back substrate constituted of a glass substrate, the use of the metal plate 5A as the base material of the back substrate 5 reduces the weight of the PDP, and improves the thermal conductivity in the back substrate 5 to allow the heat generated by a discharge in the discharge cell C1 to be released via the back substrate 5 into the air, resulting in an improvement in heat-dissipation.

Further, the aforementioned PDP structure has the column-electrode bodies D1a and the column-electrode discharge portions D1b of the column electrodes D1 formed flush with each other on the rear-facing face of the first dielectric layer 3. This structure permits simplification of the manufacturing process, leading to a substantial reduction in the manufacturing costs of the PDPs.

Still further, the aforementioned PDP structure has the bus electrodes X1a, Y1a of the row electrodes X1, Y1 serving as black or dark light absorption layers, and also the black or dark light absorption layers 2 each formed between the bus electrodes X1a and Y1a of the back-to-back row electrodes X1 and Y1 of the adjacent row electrode pairs (X1, Y1) so that the non-display zone on the panel surface is covered with light absorption layers. Hence, the reflection of ambient light incident upon the non-display zone is prevented to improve the contrast in the displayed image.

The first embodiment has described the insulation layer 7b formed on the entire surface of the partition wall 7, but an insulation layer may be on the screen-facing face and the side faces of the vertical walls and lateral walls of the partition wall, and the outer face of the metal-made base material may be joined directly to the third dielectric layer 6.

The first embodiment uses a metal-made base material for the back substrate 5 and also the partition wall 7, but the metal-made base material may be used only for the back substrate 5.

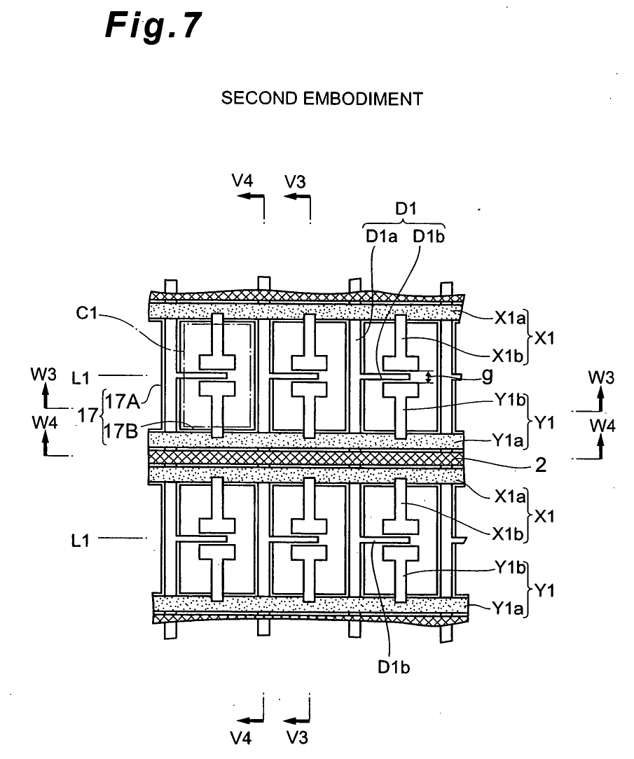

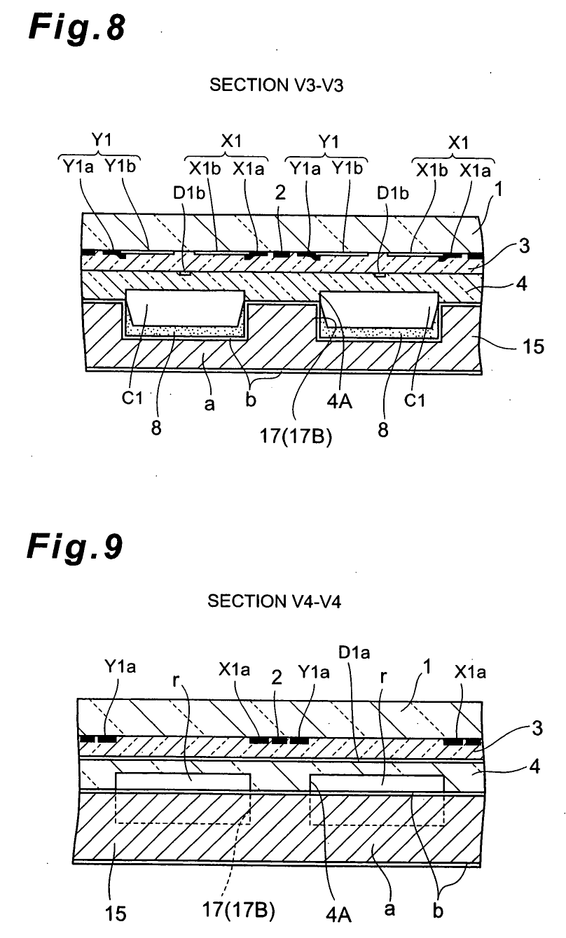

FIG. 7 to FIG. 11 illustrate a second embodiment of PDP according to the present invention: FIG. 7 is a schematic front view of the PDP and FIGS. 8, 9, 10 and 11 are sectional views respectively taken along the V3-V3 line, the V4-V4 line, the W3-W3 line and the W4-W4 line as shown in FIG. 7.

The PDP illustrated in FIG. 7 to FIG. 11 has a plurality of row electrode pairs (X1, Y1) arranged parallel to each other and extending in the row direction of a front glass substrate 1 (the right-left direction in FIG. 7) on the rear-facing face (i.e. the inner face) of the front glass substrate 1 which serves as the display screen.

The row electrode X1 is composed of a bus electrode X1a formed of a black- or dark-colored metal film extending in the row direction of the front glass substrate 1, and transparent electrodes X1b formed of a T-shaped transparent conductive film made of ITO or the like. The transparent electrodes X1b are lined up along the bus electrode X1a at regular intervals and connected at the respective proximal ends (corresponding to the foot of the T shape) to the bus electrodes X1a.

Likewise, the row electrode Y1 is composed of a bus electrode Y1a formed of a black- or dark-colored metal film extending in the row direction of the front glass substrate 1, and transparent electrodes Y1b formed of a T-shaped transparent conductive film made of ITO or the like. The transparent electrodes Y1b are lined up along the bus electrode Y1a at regular intervals and connected at the respective proximal ends to the bus electrodes Y1a.

The row electrodes X1 and Y1 are arranged in alternate positions in the column direction of the front glass substrate 1 (i.e. the vertical direction in FIG. 7). The transparent electrodes X1b and Y1b lined up along the corresponding bus electrodes X1a and Y1a at regular intervals extend toward the other of the row electrodes of the paired transparent electrodes, so that the two distal widened-ends (corresponding to the head of the T shape) of the transparent electrodes X1b and Y1b in the row electrode pair face each other with a discharge gap g having a required width in between.

Each of the row electrode pairs (X1, Y1) forms a display line L1 of the display panel.

Black- or dark-colored light absorption layers (light-shield layers) 2 are further formed on the rear-facing face of the front glass substrate 1. Each of the light absorption layers 2 is formed in a strip-shape extending in the row direction along and between the back-to-back bus electrodes X1a and Y1a of the row electrode pairs (X1, Y1) adjacent to each other in the column direction.

The row electrode pairs (X1, Y1) and the light absorption layers 2 are covered with a first dielectric layer 3 formed on the rear-facing face of the front glass substrate 1.

A plurality of column electrodes D1 is formed on the rear-facing face of the first dielectric layer 3. The column electrodes D1 each extend in the column direction and are arranged in the row direction at regular intervals.

Each of the column electrodes D1 is composed of a strip-shaped column-electrode body D1a and strip-shaped column-electrode discharge portions D1b. The column-electrode body D1a extends in a direction at right angles to the bus electrodes X1a, Y1a (i.e. in the column direction), and is opposite a position midway between the adjacent transparent electrodes X1b and the adjacent transparent electrodes Y1b which are lined up along the corresponding bus electrodes X1a and Y1a of the row electrodes X1 and Y1 at regular intervals in the row direction. The column-electrode discharge portion D1b is formed integrally with the column-electrode body D1a and extends from the side edge of the column-electrode body D1a in the row direction in each display line L1. The leading end of the column-electrode discharge portion D1b is situated opposite to a mid-position in a discharge gap g formed between the paired transparent electrodes X1b and Y1b facing each other.

The column-electrode bodies D1a and the column-electrode discharge portions D1b of the column electrodes D1 are covered with a second dielectric layer 4 formed on the rear-facing face of the first dielectric layer 3.

Bar-shaped additional dielectric layers 4A protrude from the rear-facing face of the second dielectric layer 4 toward the rear of the PDP. Each of the additional dielectric layers 4A extends along the bus electrodes X1a, Y1a in the row direction in a position opposite to the back-to-back bus electrodes X1a and Y1a of the row electrode pairs (X1, Y1) adjacent to each other and to the light absorption layer 2 provided between the back-to-back bus electrodes X1a and Y1a concerned.

A MgO-made protective layer (not shown) is formed on the rear-facing faces of the second dielectric layer 4 and the additional dielectric layers 4A.

The foregoing structure is the same as that in the first embodiment and therefore the same reference numerals are designated.

The inner face of the foregoing front glass substrate 1 faces a back substrate 15 in parallel therewith, with the discharge space in between.

A partition wall 17 is formed integrally on the back substrate 15 almost in a grid shape by strip-shaped vertical walls 17A and strip-shaped lateral walls 17B. Each of the vertical walls 17A extends in the column direction in a position opposite the column-electrode body D1a formed on the front glass substrate 1. Each of the lateral walls 17B extends in the row direction in a position opposite to the back-to-back bus electrodes X1a and Y1a of the adjacent row electrode pairs (X1, Y1) and to the light absorption layer 2 between the bus electrodes X1a and Y1a concerned.

For the formation of the partition wall 17 on the back substrate 15, chemical treatment such as etching, melting and removing techniques using a laser beam, or the like is used, and, the methods employed includes a method of forming recesses in portions of the surface of the metal substrate surrounded by portions which result in being the vertical walls 17A and the lateral walls 17B.

The back substrate 15 and the partition wall 17 are constituted of a base material a that is formed in one piece of metal and covered over the entire surface with an insulation layer b.

The partition wall 17 partitions the discharge space defined between the front glass substrate 1 and the back substrate 15 into areas each opposite to the paired transparent electrodes X1b and Y1b in the row electrode pair (X1, Y1) and the column-electrode discharge portion D1b, to individually form quadrangular discharge cells C1.

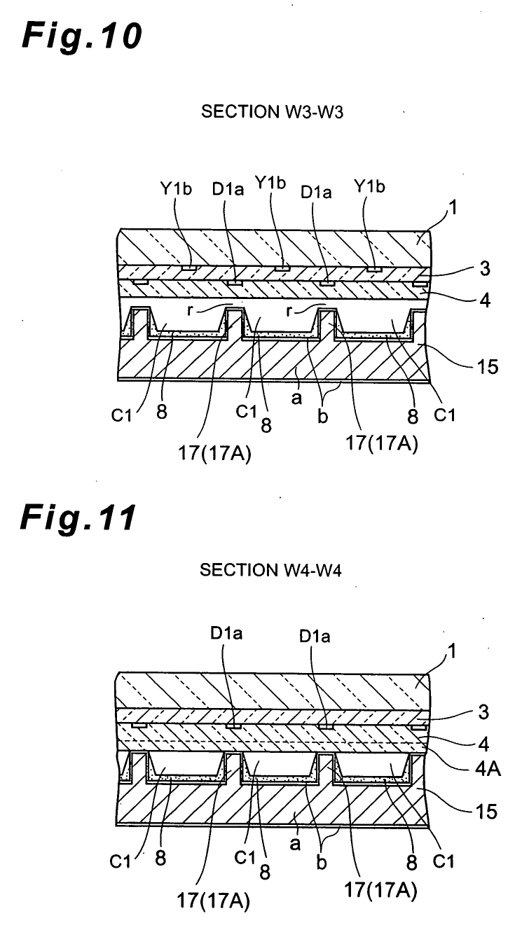

The screen-facing face of the vertical wall 17A of the partition wall 17 is out of contact with the protective layer covering the additional dielectric layer 4A (see FIGS. 9 and 10), to form a clearance r between itself and the protective layer. The screen-facing face of the lateral wall 17B is in contact with a portion of the protective layer covering the additional dielectric layer 4A, to block the adjacent discharge cells C1 from each other in the column direction (see FIGS. 8 and 11).

A phosphor layer 8 is formed in each discharge cell C1 so as to cover the five faces facing the discharge cell C1, namely, the inner face of the back substrate 15 and the side faces of the vertical walls 17A and lateral walls 17B of the partition wall 17. The phosphor layers 8 are colored in three primary colors, that is, the red (R) discharge cell C1, the green (G) discharge cell C1 and the blue (B) discharge cell C1 are arranged in order in the row direction.

The discharge space between the front glass substrate 1 and the back substrate 5 is filled with a discharge gas including xenon Xe.

The aforementioned PDP generates images as in the case of the PDP in the first embodiment.

In addition to the technical effects of the PDP in the first embodiment, the PDP in the second embodiment has the effects of further improving the heat dissipation property and further promoting cost reduction due to the simplification of the manufacturing process because of the one-piece formation of the back substrate 15 and the partition wall 17 by use of the metal-made base material a.

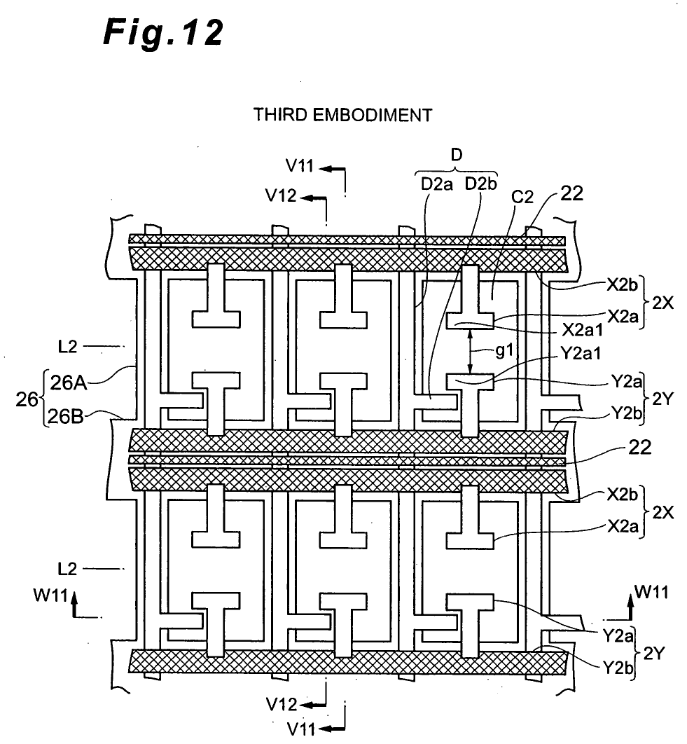

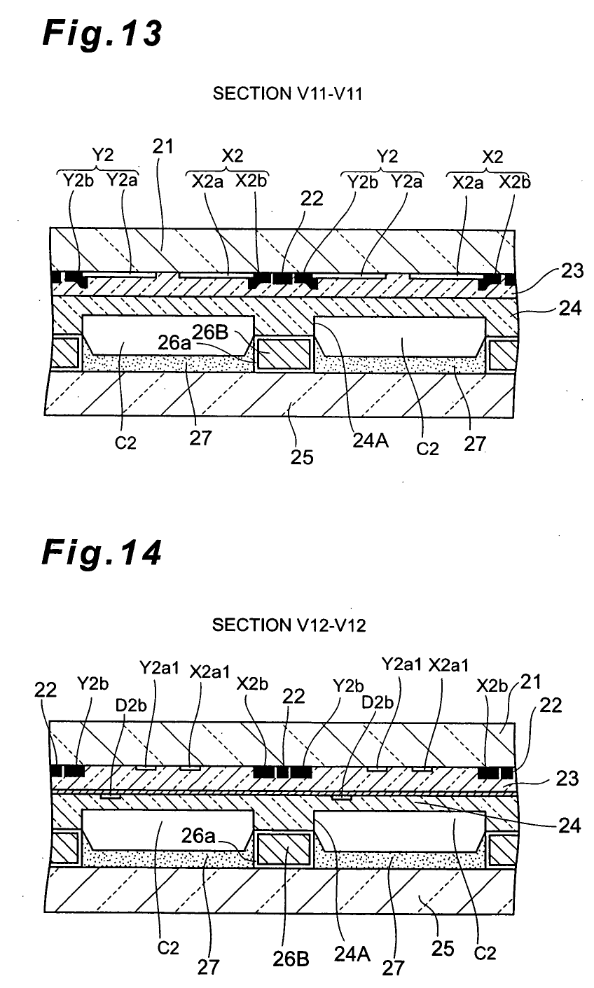

FIG. 12 to FIG. 15 illustrate a third embodiment of PDP according to the present invention: FIG. 12 is a schematic front view of the PDP and FIGS. 13, 14, and 15 are sectional views respectively taken along the V11-V11 line, the V12-V12 line and the W11-W11 line as shown in FIG. 12.

The PDP illustrated in FIG. 12 to FIG. 15 has a plurality of row electrode pairs (X2, Y2) arranged parallel to each other and extending in the row direction of a front glass substrate 21 (the right-left direction in FIG. 12) on the rear-facing face (i.e. the inner face) of the front glass substrate 21 which serves as the display screen.

The row electrode X2 is composed of transparent electrodes X2a formed of a T-shaped transparent conductive film made of ITO or the like, and a bus electrode X2b formed of a black- or dark-colored metal film extending in the row direction of the front glass substrate 21 and connected to proximal ends (corresponding to the foot of the T shape) of the respective transparent electrodes X2a.

Likewise, the row electrode Y2 is composed of transparent electrodes Y2a formed of a T-shaped transparent conductive film made of ITO or the like, and a bus electrode Y2b formed of a black- or dark-colored metal film extending in the row direction of the front glass substrate 21 and connected to proximal ends of the respective transparent electrodes Y2a.

The row electrodes X2 and Y2 are arranged in alternate positions in the column direction of the front glass substrate 21 (i.e. the vertical direction in FIG. 12). The transparent electrodes X2a and Y2a are lined up at regular intervals along and project from the corresponding bus electrodes X2b and Y2b toward their counterparts in the row electrodes of the paired transparent electrodes, so that the two top faces of a distal widened-end X2a1 (corresponding to the head of the T shape) of the transparent electrode X2a and a distal widened-end Y2a1 of the transparent electrode Y2a face each other with a discharge gap g1 having a required width in between.

Each of the row electrode pairs (X2, Y2) forms a display line L2 of the display panel.

Black- or dark-colored light absorption layers (light-shield layers) 22 are formed further on the inner face of the front glass substrate 21. Each of the light absorption layers 22 extends in the row direction along and between the back-to-back bus electrodes X2b and Y2b of the row electrode pairs (X2, Y2) adjacent to each other in the column direction.

The row electrode pairs (X2, Y2) and the light absorption layers 22 are covered with a first dielectric layer 23 formed on the inner face of the front glass substrate 21.

On the rear-facing face of the first dielectric layer 23, strip-shaped column-electrode bodies D2a each forming part of a column electrode D2 are arranged in parallel at predetermined intervals. Each of the column-electrode body D1a extends in a direction at right angles to the row electrode pairs (X2, Y2) (i.e. in the column direction), and is opposite a position midway between the adjacent transparent electrodes X2a and the adjacent transparent electrodes Y2a which are lined up along the corresponding bus electrodes X2b and Y2b of the row electrodes X2 and Y2 at regular intervals in the row direction.

Further, on the rear-facing face of the first dielectric layer 23, strip-shaped column-electrode discharge portions D2b forming part of the column electrode D2 are formed integrally with the column-electrode body D2a, such that the leading end of each of the column-electrode discharge portions D2b extends from the side of the column-electrode body D2a in the row direction to a position behind the distal widened-end Y2a1 of the transparent electrode Y2a of the row electrode Y2 when viewed from the front glass substrate 21.

The column-electrode bodies D2a and the column-electrode discharge portions D2b of the column electrodes D2 are covered with a second dielectric layer 24 formed on the rear-facing face of the first dielectric layer 23.

Additional dielectric layers 24A protrude from the rear-facing face of the second dielectric layer 24 toward the rear of the PDP. Each of the additional dielectric layers 24A extends along the bus electrodes X2b, Y2b in the row direction in a position opposite to the back-to-back bus electrodes X2b and Y2b of the row electrode pairs (X2, Y2) adjacent to each other and to the light absorption layer 22 provided between the back-to-back bus electrodes X2b and Y2b concerned.

A MgO-made protective layer (not shown) is formed on the rear-facing faces of the second dielectric layer 24 and the additional dielectric layers 24A.

The front glass substrate 21 is opposite aback glass substrate 25 with a discharge space in between. A grid-shaped partition wall 26 is formed on the screen-facing face (i.e. the inner face) of the back glass substrate 25, and composed of strip-shaped vertical walls 26A and strip-shaped lateral walls 26B. Each of the vertical walls 26A extends in the column direction in a position opposite the column-electrode body D2a formed on the front glass substrate 21. Each of the lateral walls 26B extends in the row direction in a position opposite to the back-to-back bus electrodes X2b and Y2b of the adjacent row electrode pairs (X2, Y2) and to the light absorption layer 22 between the bus electrodes X2b and Y2b concerned.

The partition wall 26 partitions the discharge space defined between the front glass substrate 21 and the back glass substrate 25 into areas each opposite to the paired transparent electrodes X2a and Y2a in each row electrode pair (X2, Y2), to individually form quadrangular discharge cells C2.

The structure of the partition wall 26 will be described in detail later.

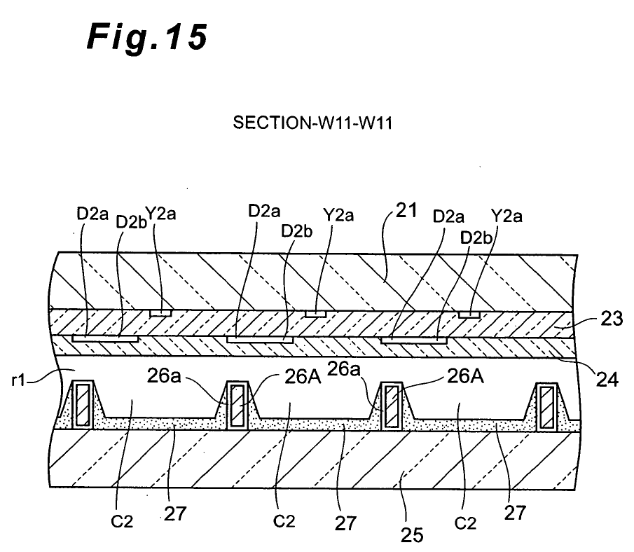

The screen-facing face of the vertical wall 26A of the partition wall 26 is out of contact with the protective layer covering the additional dielectric layer 24A, to form a clearance r1 between itself and the protective layer (see FIG. 15). The screen-facing face of the lateral wall 26B is in contact with a portion of the protective layer covering the additional dielectric layer 24A, to block the adjacent discharge cells C2 from each other in the column direction (see FIGS. 13 and 14).

A phosphor layer 27 is formed in each discharge cell C2 so as to cover the five faces facing the discharge cell C2, namely, the inner face of the back glass substrate 25 and the side faces of the vertical walls 26A and lateral walls 26B of the partition wall 26. The phosphor layers 27 are colored in three primary colors, that is, the red (R) discharge cell C2, the green (G) discharge cell C2 and the blue (B) discharge cell C2 are arranged in order in the row direction.

The discharge space between the front glass substrate 21 and the back substrate 25 is filled with a discharge gas including xenon Xe.

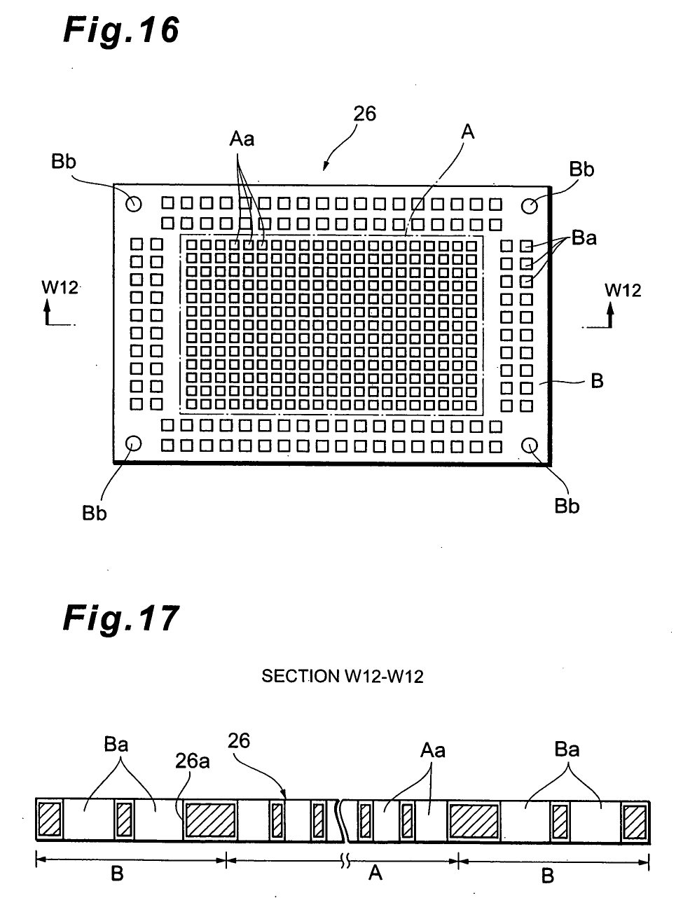

FIGS. 16 and 17 illustrate the structure of the partition wall 26. FIG. 16 is a plan view of the partition wall 26 and FIG. 17 is a sectional view taken along the W12-W12 line in FIG. 16.

In FIGS. 16 and 17, the partition wall 26 has a metal-made interior portion. A portion A of the partition wall 26 to be positioned in the display zone of the PDP has through-holes Aa with quadrangular-shaped open-ends arranged in a matrix form.

A portion B of the partition wall 26 to be positioned in the non-display zone of the display panel is formed in a flat plate shape around the display-zone portion A. A plurality of dummy through-holes Ba is formed in the non-display-zone portion B.

In the second embodiment, an open end of the dummy through-hole Ba is formed in a quadrangular shape larger in size than that of the through-hole Aa. The dummy through-holes Ba are provided in two lines at regular intervals along the display-zone portion A in the margin of each of the four sides of the non-display-zone portion B around the display-zone portion A of the metal partition wall 26.

Register-mark through-holes Bb are respectively formed in the four corners in the non-display-zone portion B of the metal partition wall 26.

As shown in FIG. 17, the entire surface of the metal partition wall 26 is covered with an insulation layer 26a.

The wall between any two lines of the through-holes Aa of the metal partition wall 26 in the lateral direction of FIG. 16 forms a vertical wall 26A. The wall between any two lines of the through-holes Aa in the vertical direction of FIG. 16 forms a lateral wall 26B.

The following description is given of the process for mounting the metal partition wall 26 on the back glass substrate 25 for the manufacturing of the display panel.

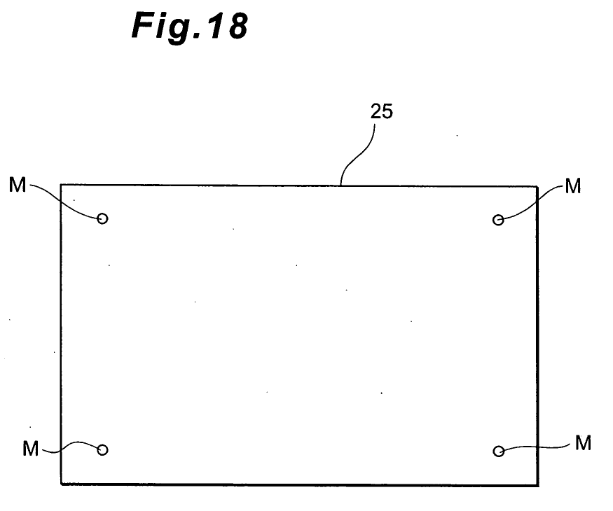

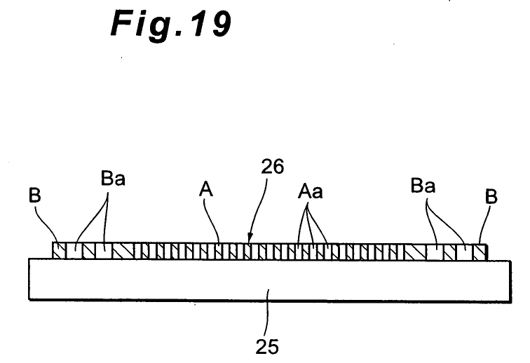

FIG. 18 is a plan view illustrating the structure of the back glass substrate of the PDP and FIG. 19 is a sectional side view of the back glass substrate with the partition wall mounted thereon.

In FIGS. 18 and 19, register marks M are respectively formed in the four corners on the inner face of the back glass substrate 25 (the upward face in FIG. 19) in correspondence with the register-mark through-holes Bb.

In the manufacturing process, the metal partition wall 26 is laid on the back glass substrate 25 having the register marks M formed as shown in FIG. 19.

At this point, the metal partition wall 26 is adjusted in position with respect to the back glass substrate 25 in a such manner as to align the four register-mark through-holes Bb formed in the corners of the metal partition wall 26 with the four register marks M formed in the corners of the back glass substrate 25.

Through this alignment, the metal partition wall 26 is properly positioned so that each of the through-holes Aa of the metal partition wall 26 will be aligned with an intersection between the row electrode pair and the column electrode formed on the front substrate which will be laid on the back glass substrate in a later process.

Then, a firing process is performed to fuse the insulation layer 26a of the metal partition wall 26 to the surface of the back glass substrate 25, so that the metal partition wall 26 is secured in place on the back glass substrate 25.

In the display-zone portion A of the metal partition wall 26, the vapor from a binder (resin component) generated during the firing process exits from the through-holes Aa formed in the display-zone portion A of the metal partition wall 26. In the non-display-zone portion B, the vapor from the binder (resin component) exits from the dummy through-holes Ba formed in the non-display-zone portion B of the metal partition wall 26.

The foregoing PDP generates images as follows.

In an addressing period subsequent to a simultaneous reset period, a scan pulse is applied to the row electrode Y2, and a display data pulse generated according to display data in an image signal is applied to the column-electrode body D2a of the column electrode D2. Thereupon, selectively, an addressing discharge is produced between the column-electrode discharge portion D2b of the column electrode D2 and the transparent electrode Y2a of the row electrode Y2 receiving the scan pulse.

As a result, the discharge cells (lighted cells) C2 having wall charges generated on the first dielectric layer 23 and the second dielectric layer 24, and the discharge cells (non-lighted cells) C2 having no wall charge generated are distributed over the panel surface.

In the sustaining emission period subsequent to the addressing period, a discharge sustaining pulse is applied to the row electrodes X2 and Y2. Thereupon, in the discharge cells having the wall charges formed on the first and second dielectric layers 23 and 24, a sustain discharge is produced between the transparent electrodes X2a and Y2a of the row electrodes X2 and Y2 facing each other with the discharge gap g1 in between. The sustain discharge effects the radiation of vacuum ultraviolet light from the xenon included in the discharge gas sealed in the discharge space. The vacuum ultraviolet light excites the red-, green- and blue-colored phosphor layers 27 to allow the phosphor layers to emit visible light for the generation of the image in the form of matrix display.

In the aforementioned structure of the PDP, both the row electrode pairs (X2, Y2) and the column electrodes D2 are formed on the front glass substrate 21. Further, the column-electrode body D2a and the column-electrode discharge portion D2b of the column electrode D2 are formed flush with each other on the rear-facing face of the first dielectric layer 23. This structure permits the simplification of the manufacturing process and thereby a substantial reduction in the manufacturing costs of the PDP.

Further, for the formation of the partition wall 26, a metal partition wall pre-formed in a required shape is mounted on the back glass substrate 25. Hence, it is possible to simplify the manufacturing process. Further, the alignment between the metal partition wall 26 and the back and front glass substrates 25 and 21 becomes easy, resulting in a further simplification of the manufacturing process.

Still further the aforementioned PDP structure has the bus electrodes X2b, Y2b of the row electrodes X2, Y2 serving as black or dark light absorption layers, and also the black or dark light absorption layers 22 each formed between the bus electrodes X2b and Y2b of the back-to-back row electrodes X2 and Y2 of the adjacent row electrode pairs (X2, Y2), so that the non-display zone on the panel surface is covered with light absorption layers. Hence, the reflection of ambient light incident upon the non-display zone is prevented to improve the contrast in the displayed image.

The third embodiment has described the first dielectric layer 23 covering the row electrode pairs (X2, Y2) formed on the inner face of the front glass substrate 21, and the second dielectric layer 24 covering the column electrodes D2 formed on the rear-facing face of the first dielectric layer 23. However, the positions of the row electrode pairs (X2, Y2) and the column electrodes D2 may be reversed so that the column electrodes D2 may be formed on the inner face of the front glass substrate 21 and covered with the first dielectric layer 23, and the row electrode pairs (X2, Y2) may be formed on the rear-facing face of the first dielectric layer 23 and covered with the second dielectric layer 24.

The PDP in the third embodiment has the alternate arrangement of the row electrodes X2 and Y2 in the column direction, namely, the order X2-Y2, X2-Y2, etc., but the arrangement of the row electrodes is not limited to this. The positions of the row electrodes X2 and Y2 of each row electrode pair (X2, Y2) may be interchanged from one row electrode pair to another, namely, the order X2-Y2, Y2-X2, X2-Y2, Y2-X2, etc., so that in between the adjacent display lines, the row electrodes X2 may be placed back to back with each other and the row electrodes Y2 may be placed back to back with each other.

In this case, the single bus electrode of the back-to-back row electrodes X2 or the back-to-back row electrodes Y2 may be used for both the adjacent display lines.

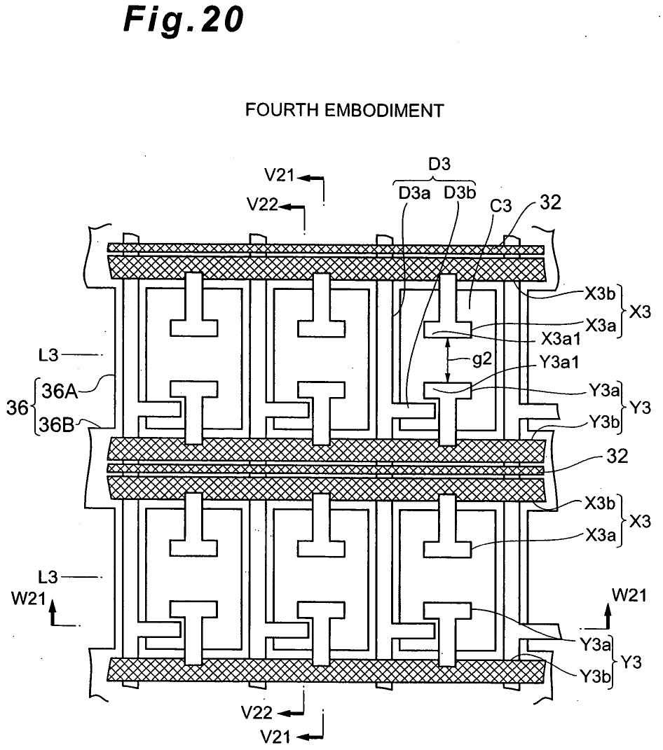

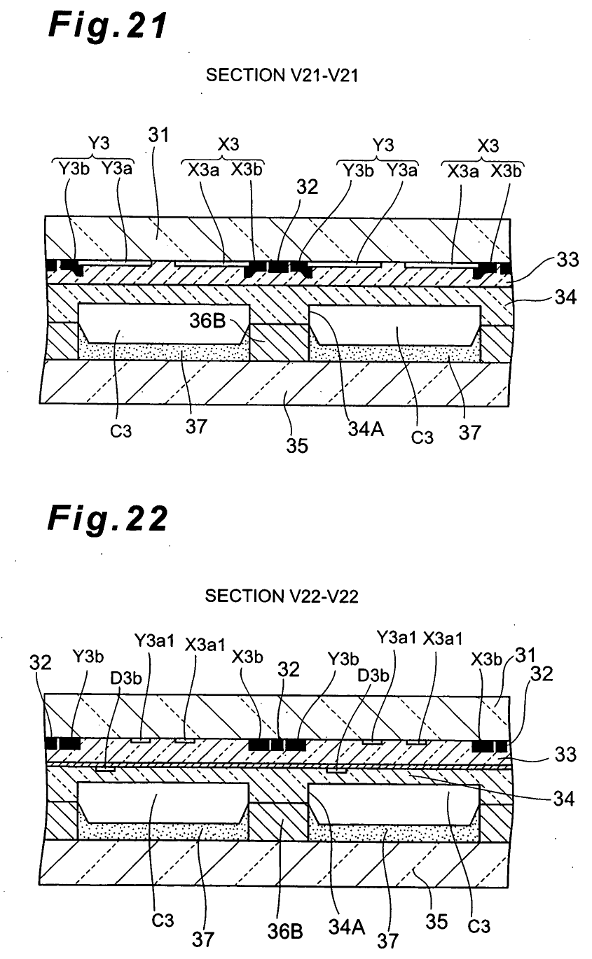

FIG. 20 to FIG. 23 illustrate a fourth embodiment of PDP according to the present invention: FIG. 20 is a schematic front view of the PDP and FIGS. 21, 22, and 23 are sectional views respectively taken along the V21-V21 line, the V22-V22 line and the W21-W21 line as shown in FIG. 20.

Referring to FIGS. 20 to 23, a plurality of row electrode pairs (X3, Y3) that are arranged in parallel and each extend in the row direction of a front glass substrate 31 (the right-left direction in FIG. 20) is formed on the rear-facing face (i.e. the inner face) of the front glass substrate 31 which serves as the display screen.

The row electrode X3 is composed of transparent electrodes X3a formed of a T-shaped transparent conductive film made of ITO or the like, and a bus electrode X3b formed of a black- or dark-colored metal film extending in the row direction of the front glass substrate 31 and connected to proximal ends (corresponding to the foot of the T shape) of the respective transparent electrodes X3a.

Likewise, the row electrode Y3 is composed of transparent electrodes Y3a formed of a T-shaped transparent conductive film made of ITO or the like, and a bus electrode Y3b formed of a black- or dark-colored metal film extending in the row direction of the front glass substrate 31 and connected to proximal ends of the respective transparent electrodes Y3a.

The row electrodes X3 and Y3 are arranged in alternate positions in the column direction of the front glass substrate 31 (i.e. the vertical direction in FIG. 20). The transparent electrodes X3a and Y3a are lined up along and projects from the corresponding bus electrodes X3b and Y3b toward their counterparts in the paired transparent electrodes, so that the two tops of a distal widened-end X3a1 (corresponding to the head of the T shape) of the transparent electrode X3a and a distal widened-end Y3a1 of the transparent electrode Y3a face each other with a discharge gap g2 having a required width in between.

Each of the row electrode pairs (X3, Y3) forms a display line L3 of the display panel.

Black- or dark-colored light absorption layers (light-shield layers) 32 are further formed on the inner face of the front glass substrate 31. Each of the light absorption layers 32 extends in the row direction along and between the back-to-back bus electrodes X3b and Y3b of the row electrode pairs (X3, Y3) adjacent to each other in the column direction.

The row electrode pairs (X3, Y3) and the light absorption layers 32 are covered with a first dielectric layer 33 formed on the inner face of the front glass substrate 31.

On the rear-facing face of the first dielectric layer 33, strip-shaped column-electrode bodies D3a each forming part of a column electrode D3 are arranged in parallel at predetermined intervals. Each of the column-electrode bodies D3a extends in a direction at right angles to the row electrode pairs (X3, Y3) (i.e. in the column direction), and is opposite a position midway between the adjacent transparent electrodes X3a and the adjacent transparent electrodes Y3a which are lined up along the corresponding bus electrodes X3b and Y3b of the row electrodes X3 and Y3 at regular intervals in the row direction.

Further, on the rear-facing face of the first dielectric layer 33, strip-shaped column-electrode discharge portions D3b forming part of the column electrode D3 are formed integrally with the column-electrode body D3a. The leading end of each of the column-electrode discharge portions D3b extends from the side of the column-electrode body D3a in the row direction to a position behind the distal widened-end Y3a1 of the transparent electrode Y3a of the row electrode Y3 when viewed from the front glass substrate 31.

The column-electrode bodies D3a and the column-electrode discharge portions D3b of the column electrodes D3 are covered with a second dielectric layer 34 formed on the rear-facing face of the first dielectric layer 33.

Additional dielectric layers 34A protrude from the rear-facing face of the second dielectric layer 34 toward the rear of the PDP. Each of the additional dielectric layers 34A extends along the bus electrodes X3b, Y3b in the row direction in a position opposite to the back-to-back bus electrodes X3b and Y3b of the row electrode pairs (X3, Y3) adjacent to each other and to the light absorption layer 32 provided between the back-to-back bus electrodes X3b and Y3b concerned.

A MgO-made protective layer (not shown) is formed on the rear-facing faces of the second dielectric layer 34 and the additional dielectric layers 34A.

The front glass substrate 31 is opposite a back glass substrate 35 with a discharge space in between. A grid-shaped partition wall 36 is formed on the screen-facing face (i.e. the inner face) of the back glass substrate 35, and composed of strip shaped vertical walls 36A and strip-shaped lateral walls 36B. Each of the vertical walls 36A extends in the column direction in a position opposite the column-electrode body D3a formed on the front glass substrate 31. Each of the lateral walls 36B extends in the row direction in a position opposite to the back-to-back bus electrodes X3b and Y3b of the adjacent row electrode pairs (X3, Y3) and to the light absorption layer 32 between the bus electrodes X3b and Y3b concerned.

The partition wall 36 partitions the discharge space defined between the front and back glass substrates 31 and 35 into areas each opposite to the paired transparent electrodes X3a and Y3a in each row electrode pair (X3, Y3) to individually form quadrangular discharge cells C3.

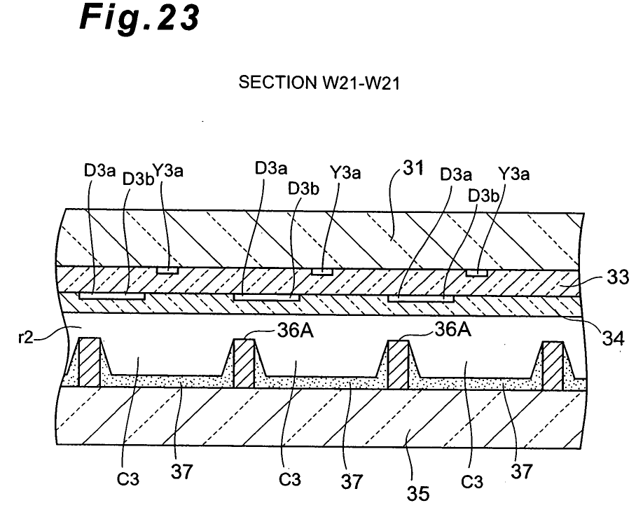

The screen-facing face of the vertical wall 36A of the partition wall 36 is out of contact with the protective layer covering the additional dielectric layer 34A, to form a clearance r2 between itself and the protective layer (see FIG. 23). The screen-facing face of the lateral wall 36B is in contact with a portion of the protective layer covering the additional dielectric layer 34A, to block the adjacent discharge cells C3 from each other in the column direction (see FIGS. 21 and 22).

A phosphor layer 37 is formed in each discharge cell C3 so as to cover the five faces facing the discharge cell C3, namely, the inner face of the back glass substrate 35, and the side faces of the vertical walls 36A and lateral walls 36B of the partition wall 36. The phosphor layers 37 are colored in three primary colors, that is, the red (R) discharge cell C3, the green (G) discharge cell C3 and the blue (B) discharge cell C3 are arranged in order in the row direction.

The discharge space between the front and back glass substrates 31 and 35 is filled with a discharge gas of a noble-gas mixture including 10 percent or more of xenon Xe.

The foregoing PDP generates images as follows.

In an addressing period subsequent to a simultaneous-reset period, a scan pulse is applied to the row electrode Y3, and a display data pulse generated according to display data in an image signal is applied to the column-electrode body D3a of the column electrode D3. Thereupon, selectively, an addressing discharge is produced between the column-electrode discharge portion D3b of the column electrode D3 and the transparent electrode Y3a of the row electrode Y3 receiving the scan pulse.

As a result, the discharge cells (lighted cells) C3 having wall charges generated on the first dielectric layer 33 and the second dielectric layer 34, and the discharge cells (non-lighted cells) C3 having no wall charge generated are distributed over the panel surface.

In the sustaining emission period subsequent to the addressing period, a discharge sustaining pulse is applied to the row electrodes X3 and Y3. Thereupon, in the discharge cells having the wall charges formed on the first and second dielectric layers 33 and 34, a sustain discharge is produced between the transparent electrodes X3a and Y3a of the row electrodes X3 and Y3 facing each other with the discharge gap g2 in between. The sustain discharge effects the radiation of vacuum ultraviolet light from the xenon included in the discharge gas sealed in the discharge space. The vacuum ultraviolet light excites the red-, green- and blue-colored phosphor layers 37 to allow the phosphor layers to emit visible light for the generation of the image in the form of matrix display.

At this point, because the discharge gas sealed in the discharge space includes 10 percent or more of xenon, the amount of radiation of vacuum ultraviolet light from the xenon is increased as compared with the case in the conventional three-electrode reflection-type plasma display panels, and therefore the amount of light emitted from the phosphor layers 37 excited by the vacuum ultraviolet light is increased.

In the foregoing PDP the column electrode D3 and the row electrode pair (X3, Y3) of the foregoing PDP are formed on the same front glass substrate 31, so that there is only a short distance between the transparent electrode Y3a of the row electrode Y and the column-electrode discharge portion D3b of the column electrode D3 between which the addressing discharge is caused. For this reason, even in the use of a noble-gas mixture including 10 percent or more of xenon as the discharge gas, it is possible to reduce the starting voltage required for starting an addressing discharge as compared with the conventional three-electrode reflection-type PDP.

The fourth embodiment has described the row electrode pairs (X3, Y3) formed on the inner face of the front glass substrate 31 and covered with the first dielectric layer 33, and the column electrodes D3 formed on the inner face of the first dielectric layer 33 and covered with the second dielectric layer 24. However, the positions of the row electrode pairs (X3, Y3) and the column electrodes D3 may be reversed so that the column electrodes D3 may be formed on the inner face of the front glass substrate 31 and covered with the first dielectric layer 33, and the row electrode pairs (X3, Y3) may be formed on the inner face of the first dielectric layer 33 and covered with the second dielectric layer 34.

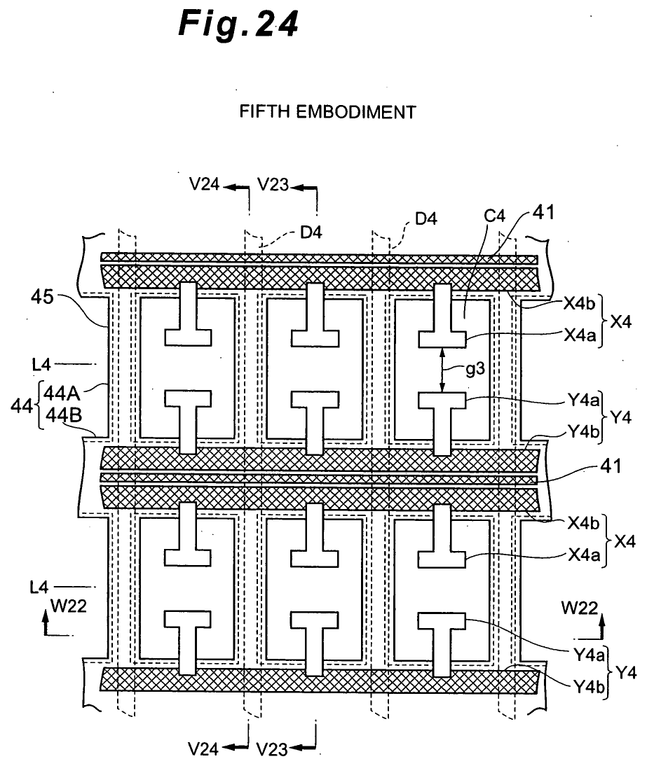

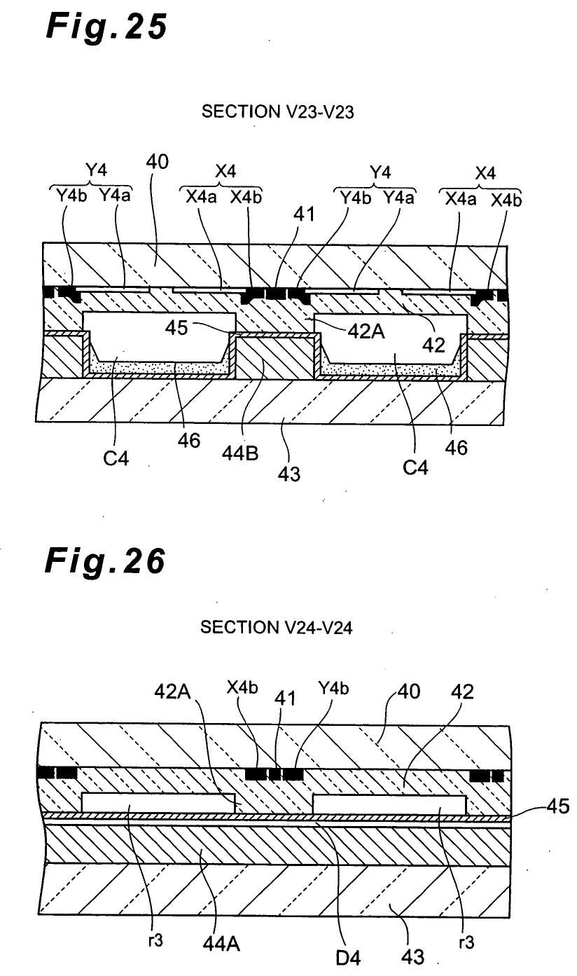

FIGS. 24 to 27 illustrate a fifth embodiment of the PDP according to the present invention: FIG. 24 is a schematic front view of the PDP and FIGS. 25, 26 and 27 are sectional views respectively taken along the V23-V23 line, the V24-V24 line and the W22-W22 line shown in FIG. 24.

In FIGS. 24 to 27, a plurality of row electrode pairs (X4, Y4) that are arranged in parallel and each extend in the row direction of a front glass substrate 40 (the right-left direction in FIG. 24) is formed on the rear-facing face (i.e. the inner face) of the front glass substrate 40 which serves as the display screen.

The row electrode X4 is composed of transparent electrodes X4a formed of a T-shaped transparent conductive film made of ITO or the like, and a bus electrode X4b formed of a black- or dark-colored metal film extending in the row direction of the front glass substrate 40 and connected to proximal ends (corresponding to the foot of the T shape) of the respective transparent electrodes X4a.

Likewise, the row electrode Y4 is composed of transparent electrodes Y4a formed of a T-shaped transparent conductive film made of ITO or the like, and a bus electrode Y4b formed of a black- or dark-colored metal film extending in the row direction of the front glass substrate 40 and connected to proximal ends of the respective transparent electrodes Y4a.

The row electrodes X4 and Y4 are arranged in alternate positions in the column direction of the front glass substrate 40 (i.e. the vertical direction in FIG. 24). The transparent electrodes X4a and Y4a are lined up along and projects from the corresponding bus electrodes X4b and Y4b toward their counterparts in the paired transparent electrodes, so that the two tops of widened-ends (corresponding to the heads of the T shape) of the respective transparent electrodes X4a and Y4a face each other with a discharge gap g3 having a required width in between.

Each of the row electrode pairs (X4, Y4) forms a display line L4 of the display panel.

Black- or dark-colored light absorption layers (light-shield layers) 41 are further formed on the inner face of the front glass substrate 40. Each of the light absorption layers 41 extends in the row direction along and between the back-to-back bus electrodes X4b and Y4b of the row electrode pairs (X4, Y4) adjacent to each other in the column direction.

The row electrode pairs (X4, Y4) and the light absorption layers 41 are covered with a dielectric layer 42 formed on the inner face of the front glass substrate 40.

Additional dielectric layers 42A protrude from the rear-facing face of the dielectric layer 42 toward the rear of the PDP. Each of the additional dielectric layers 42A extends along the bus electrodes X4b, Y4b in the row direction in a position opposite to the back-to-back bus electrodes X4b and Y4b of the row electrode pairs (X4, Y4) adjacent to each other and to the light absorption layer 41 provided between the back-to-back bus electrodes X4b and Y4b concerned.

A MgO-made protective layer (not shown) is formed on the rear-facing faces of the dielectric layer 42 and the additional dielectric layers 42A.

The front glass substrate 40 is opposite a back glass substrate 43 with a discharge space in between. A grid-shaped partition wall 44 is formed on the screen-facing face (i.e. the inner face) of the back glass substrate 43, and composed of strip-shaped vertical walls 44A and strip-shaped lateral walls 44B. Each of the vertical walls 44A extends in a direction at right angles to the row electrode pair (4X, 4Y) (i.e. in the column direction), and is opposite a position midway between the adjacent transparent electrodes X4a and the adjacent transparent electrodes Y4a which are lined up along the corresponding bus electrodes X4b and Y4b of the row electrodes X4 and Y4 at regular intervals in the row direction. Each of the lateral walls 44B extends in the row direction in a position opposite to the back-to-back bus electrodes X4b and Y4b of the adjacent row electrode pairs (X4, Y4) and to the light absorption layer 41 between the bus electrodes X4b and Y4b concerned.

The partition wall 44 partitions the discharge space defined between the front and back glass substrates 40 and 43 into areas each opposite to the paired transparent electrodes X4a and Y4a in each row electrode pair (X4, Y4), to individually form quadrangular discharge cells C4.

A column electrode D4 extends in the column direction on one of the upper side-corners of each of the vertical walls 44A of the partition wall 44 so as to cover parts of the top face and the side face of the corner.

A column-electrode protective dielectric layer 45 covers all the faces of the partition wall 44, the column electrodes D4 and the back glass substrate 43.

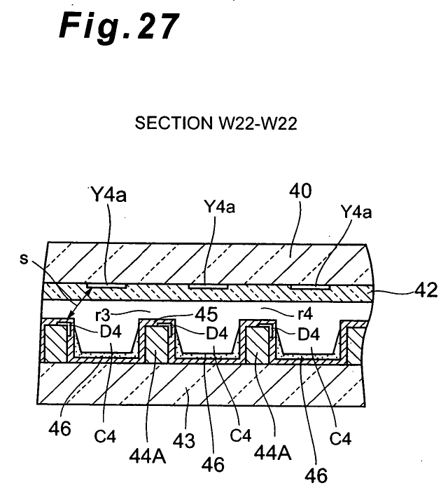

The portion of the column-electrode protective dielectric layer 45 covering the top face (i.e. the face facing the display screen) of the vertical wall 44A of the partition wall 44 is out of contact with the protective layer covering the additional dielectric layer 44A, to form a clearance r3 between the portion and the protective layer (see FIGS. 26 and 27). The portion of the column-electrode protective dielectric layer 45 covering the top face (i.e. the face facing the display screen) of the lateral wall 44B is in contact with the portion of the protective layer covering the additional dielectric layer 42A, to block the adjacent discharge cells C4 from each other in the column direction (see FIG. 25).

A phosphor layer 46 is formed in each discharge cell C4 so as to cover the portions of the column-electrode protective dielectric layer 45 facing the discharge cell C4 and covering the face of the back glass substrate 43 and the side faces of the vertical walls 46A and lateral walls 46B of the partition wall 46. The phosphor layers 46 are colored individually in three primary colors, that is, the red (R) discharge cell C4, the green (G) discharge cell C4 and the blue (B) discharge cell C4 are arranged in order in the row direction.

The discharge space between the front and back glass substrates 40 and 43 is filled with a discharge gas of a noble-gas mixture including 10 percents or more of xenon (Xe).

The foregoing PDP generates images as follows.

In an addressing period subsequent to a simultaneous-reset period, a scan pulse is applied to the row electrode Y4, and a display data pulse generated according to display data in an image signal is applied to the column electrode D4. Thereupon, selectively, an addressing discharge s is produced between the column electrode D4 and the transparent electrode Y4a of the row electrode Y4 receiving the scan pulse (see FIG. 27).

As a result, the discharge cells (lighted cells) C4 having wall charges generated on the dielectric layer 42, and the discharge cells (non-lighted cells) C4 having no wall charge generated are distributed over the panel surface.

In the sustaining emission period subsequent to the addressing period, a discharge sustaining pulse is applied to the row electrodes X4 and Y4. Thereupon, in the discharge cells C4 having the wall charges formed on the dielectric layer 42, a sustain discharge is produced between the transparent electrodes X4a and Y4a of the row electrodes X4 and Y4 facing each other with the discharge gap g3 in between. The sustain discharge effects the radiation of vacuum ultraviolet light from the xenon included in the discharge gas sealed in the discharge space. The vacuum ultraviolet light excites the red-, green- and blue-colored phosphor layers 46 to allow the phosphor layers to emit visible light for the generation of the image in the form of matrix display.

At this point, because the discharge gas sealed in the discharge space includes 10 percent or more of xenon, the amount of radiation of vacuum ultraviolet light from the xenon is increased as compared with the case in the conventional three-electrode reflection-type plasma display panels, and therefore the amount of light emitted from the phosphor layers 46 excited by the vacuum ultraviolet light is increased.

In the foregoing PDP the column electrode D4 is formed on the top portion of the vertical wall 44A of the partition wall 44, so that there is only a short distance between the transparent electrode Y4a of the row electrode Y4 and the column electrode D4 between which the addressing discharge is caused. For this reason, even in the use of a noble-gas mixture including 10 percent or more of xenon as the discharge gas, it is possible to reduce the starting voltage required for starting an addressing discharge as compared with the conventional three-electrode reflection-type PDP.

The PDP in the fifth embodiment has the alternate arrangement of the row electrodes X4 and Y4 in the column direction, namely, the order X4-Y4, X4-Y4, etc., but the arrangement of the row electrodes is not limited to this. The positions of the row electrodes X4 and Y4 of each row electrode pair (X4, Y4) may be interchanged from one row electrode pair to another, namely, the order X4-Y4, Y4-X4, X4-Y4, Y4-X4, etc., so that in between the adjacent display lines, the row electrodes X4 may be placed back to back with each other and the row electrodes Y4 may be placed back to back with each other.

In this case, the single bus electrode of the back-to-back row electrodes X4 or the back-to-back row electrodes Y4 may be used for both the adjacent display lines.

The terms and description used herein are set forth by way of illustration only and are not meant as limitations. Those skilled in the art will recognize that numerous variations are possible within the spirit and scope of the invention as defined in the following claims.

What is claimed is:

1. A plasma display panel comprising:
a front substrate;
a back substrate constituted of a metal plate having a surface covered with an insulation layer, and located opposite the front substrate with a discharge space in between;
a plurality of row electrode pairs each extending in a row direction and regularly arranged in a column direction on a rear-facing face of the front substrate to individually form display lines;
a plurality of column electrodes each extending in a direction at right angles to the row electrode pair on the rear-facing face of the front substrate, and each separated from the row electrode pair by a dielectric layer; and
a partition wall for partitioning the discharge space into unit light-emission areas each positioned opposite to discharge portions facing each other in each row electrode pair.

2. A plasma display panel according to claim 1, wherein the partition wall is constituted of a metal base material having the surface covered with an insulation layer.

3. A plasma display panel according to claim 2, wherein the partition wall is formed approximately in a grid shape by vertical walls each extending in the column direction and regularly arranged in the row direction, and lateral walls each extending in the row direction and regularly arranged in the column direction.

4. A plasma display panel according to claim 1,
further comprising a dielectric layer formed on a face of the back substrate facing the discharge space,
wherein the partition wall is secured to the back substrate through the dielectric layer.

5. A plasma display panel according to claim 1, wherein the back substrate and the partition wall are formed in one piece by use of a metal base material, and a surface of the metal base material is covered with an insulation layer.

6. A plasma display panel according to claim 5, wherein the partition wall formed integrally with the back substrate is created by forming recesses in a surface of the meal plate by use of etching treatment.

7. A plasma display panel comprising:
a pair of first and second substrates opposite each other with a discharge space in between;
a plurality of row electrode pairs each extending in a row direction and regularly arranged in a column direction on the first substrate;
a plurality of column electrodes each extending in the column direction and regularly arranged in the row direction on the first substrate, and each having a portion providing for initiating a discharge in association with one row electrode in the row electrode pair;
dielectric layers provided on the first substrate and covering the row electrode pairs and the column electrodes;
unit light-emission areas formed in the discharge space at each area corresponding to opposed portions in each row electrode pair; and
a metal-made partition wall having a metal surface covered with an insulation layer, and provided between the first and second substrates for defining each of the unit light-emission areas.

8. A plasma display panel according to claim 7, wherein the first substrate is a front substrate which will be on a display screen side, and the column electrode is formed in a different plane from a plane of the row electrode pair in a thickness direction of the first substrate.

9. A plasma display panel according to claim 8, wherein the dielectric layer covering the row electrode pairs is a first dielectric layer, and the dielectric layer covering the column electrodes is a second dielectric layer formed on an inner face of the first dielectric layer.

10. A plasma display panel according to claim 7, wherein each of the row electrodes constituting each of the row electrode pairs comprises a row-electrode body extending in the row direction, and row-electrode projecting portions each projecting from the row-electrode body toward its counterpart in the row electrode pair in each unit light-emission area to face a row-electrode projecting portion of the counterpart with a discharge gap in between.

11. A plasma display panel according to claim 7, wherein the column electrode comprises a column-electrode body extending in the column direction, and column-electrode discharge portions each extending from the column-electrode body toward the one row electrode in the row electrode pair.

12. A plasma display panel according to claim 7, wherein the metal-made partition wall has unit-light-emission-area through-holes provided for defining the unit light-emission areas and arranged in a matrix form in positions corresponding to the unit light-emission areas.

13. A plasma display panel according to claim 7, further comprising firing-process-used through-holes providing for a firing process and formed in a portion of the metal-made partition wall opposite a non-display zone in the first substrate.

14. A plasma display panel according to claim 7, further comprising:
register marks marked on selected positions on the inner face of the second substrate; and
register-mark through-holes formed in positions on the metal-made partition wall opposite the register marks marked on the second substrate.

15. A plasma display panel according to claim 11, wherein the metal-made partition wall has through holes provided for defining the unit light-emission areas and arranged in a matrix form in positions corresponding to the unit light-emission areas, and the column-electrode body of the column electrode is opposite a portion between the through holes of the metal-made partition wall adjacent to each other in the row direction.

16. A plasma display panel according to claim 7, wherein the row-electrode body is formed of one of a black-colored light absorption layer and a dark-colored light absorption layer.

17. A plasma display panel according to claim 7, further comprising one of a black-colored light absorption layer and a dark-colored light absorption layer formed between the two back-to-back row electrodes of the respective row electrode pairs adjacent to each other.

18. A plasma display panel according to claim 7, further comprising phosphor layers formed on the second substrate.

19. A plasma display panel comprising:
a pair of first and second substrates opposite each other with a discharge space in between;
a plurality of row electrode pairs each extending in a row direction and arranged regularly in a column direction on the first substrate;
a dielectric layer provided on the first substrate and covering the row electrode pairs;
phosphor layers provided on the second substrate;
unit light-emission areas defined inside the discharge space between the pair of first and second substrates in each area corresponding to opposed portions of the row electrodes constituting each row electrode pair;
a partition wall provided between the pair of first and second substrates for defining each of the unit light-emission areas;
a plurality of column electrodes arranged regularly in the row direction and each extending in the column direction in a position at a shorter distance from the one row electrode than a distance between the pair of first and second substrates, to provide for initiating a discharge in association with the one row electrode in each row electrode pair; and
a discharge gas of a noble-gas mixture including 10 percent or more of xenon sealed in the discharge space.

20. A plasma display panel according to claim 19, wherein the first substrate is a front substrate which will be on a display screen side, and the column electrodes, together with the row electrode pairs, are placed within the dielectric layer.

21. A plasma display panel according to claim 20, wherein the column electrode is formed in a different plane from a plane of the row electrode pair in the thickness direction of the first substrate.

22. A plasma display panel according to claim 21, wherein the row electrode pairs are covered with a first dielectric layer of the dielectric layer and the column electrodes are covered with a second dielectric layer of the dielectric layer formed on an inner face of the first dielectric layer.

23. A plasma display panel according to claim 20, wherein the column electrode comprises a column-electrode body extending in the column direction, and column-electrode discharge portions each extending from the column-electrode body toward a position closer to the one row electrode in the row electrode pair than to the other row electrode.

24. A plasma display panel according to claim 20, wherein the partition wall has vertical walls each extending in the column direction for defining each of the unit light-emission areas in the row direction,
wherein the column electrode has a column-electrode body extending in the column direction, and column-electrode discharge portions each extending from the column-electrode body toward a position closer to the one row electrode in the row electrode pair than to the other row electrode, and
wherein the column-electrode body of the column electrode is positioned opposite the vertical wall of the partition wall.

25. A plasma display panel according to claim 19, wherein the partition wall has vertical walls each extending in the column direction for defining each of the unit light-emission areas in the row direction, and the column electrode is positioned on a portion of the vertical wall close to the first substrate.

26. A plasma display panel according to claim 25, wherein the column electrode is formed on a top portion of the vertical wall of the partition wall facing the first substrate.

27. A plasma display panel according to claim 25, wherein the column electrode is formed on an upper side corner portion of the vertical wall of the partition wall facing toward the one row electrode for initiating a discharge.

28. A plasma display panel according to claim 25, wherein the partition walls and the column electrodes are covered with a dielectric layer.

29. A plasma display panel according to claim 19, wherein each of the row electrodes constituting each row electrode pair comprises a row-electrode body extending in the row direction, and row-electrode projecting portions each projecting from the row-electrode body toward its counterpart in the row electrode pair in each unit light-emission area to face a row-electrode projecting portion of the counterpart with a discharge gap in between.
